(19) United States
(12) Patent Application Publication
(10) Pub. No.: US 2012/0137882 A1
(43) Pub. Date: Jun. 7, 2012

(54) Method For Treating Hydrocarbon Fluids Using Pulsting Electromagnetic Wave in Combination With Induction Heating

(76) Inventor: Hwee Hong Chew, Singapore (SG)

(21) Appl. No.: 13/201,454

(22) PCT Filed: Feb. 13, 2009
(86) PCT No.: PCT/CN2009/070422

§ 371 Date: Feb. 25, 2012

(51) Int. Cl. C02F 1/461; C25B 9/04; B01D 53/14; C25B 15/02

(52) U.S. Cl. 95/149; 205/742; 204/242; 204/230.2; 204/230.5

(57) ABSTRACT

A method for electrolytically producing alkaline water comprises the steps of (a) providing an electrolytic cell (50) containing at least one anode electrode (30) and at least one cathode electrode (40) in a spaced manner, without a separator or a diaphragm arranged between at least one anode electrode (30) and at least one cathode electrode (40), both the anode and cathode electrodes being made of magnesium; (b) supplying water to the electrolytic cell (50); and (c) applying a direct current across at least one anode electrode and at least one cathode electrode for causing electrolysis of water in the electrolytic cell (50) to produce alkaline water. An apparatus (100) corresponding to the method and the use of the alkaline water produced by the method are also provided.

### FIELD OF THE INVENTION

The present invention relates to method and apparatus for producing alkaline water of high pH value, and more particularly, to method and apparatus for electrolytically producing alkaline water of high pH value utilizing magnesium as anode and cathode electrodes without a separator therebetween, and the use of the produced alkaline water.

### BACKGROUND OF THE INVENTION

Use of a common electrolysis apparatus to increase pH value of water is well known in the art. Generally, electrolysis is a very useful and simple process for separating chemically bonded elements and compounds, which is performed by applying an electric current across a pair of electrodes, anode and cathode, immersed in electrolyte such as water or aqueous water. The electrolyte is the medium to conduct electricity as it consists of free ions in solution.

One important application of electrolysis is to produce oxygen and hydrogen by electrolyzing water in an electrolytic cell having a separator arranged between the anode and the cathode. In this case, acid water is produced at the anode and alkaline water is produced at the cathode.

It is found that alkaline water finds a wide range of applications. For example, alkaline water is useful for drinking, disinfecting and cleaning, depressing an abnormal intestinal fermentation and the like. Another application is that alkaline water is able to remove toxic components and greenhouse gases SO₂, NOₓ, and CO₂ in a flue gas, because of the high pH value and the alkalinity of the alkaline water.

The alkaline water can be produced electrolytically with currently available equipment that electrolyzes tap water or seawater. Inert materials are commonly used as electrodes in the electrolysis because the consumption rate of the inert materials is usually insignificant. However, electrolyzing seawater or saline water using electrodes of inert materials always results in the generation of chlorine gas at the anode side, which is likely to re-dissolve back to the water treated, and thus decreases the pH value of water. This consequently affects the rate or performance of generation of alkaline water of high pH value. In addition, chlorine gas is known to be harmful to human health and the environment, especially to the organisms living in seawater and soil.

U.S. Pat. No. 6,527,940 discloses a production method of acid water and alkaline water in a water electrolytic cell which is partitioned by a cation-exchange membrane. However, this method requires a membrane of high cost and complicated maintenance work. In the method of this patent, the performance and rate of production of acid water and alkaline water largely depends on the condition of the membrane, and the rate of alkaline water production is reduced if the leakage of the membrane used takes place.

U.S. Pat. No. 6,638,364 discloses cleaning system and method using electrolyzed alkaline water. In this patent, chlorine gas is generated on the anode side when the alkaline water is produced in the direct electrolysis of saline water. As mentioned above, chlorine gas is harmful to the environment and thus unwanted. Another disadvantage of this patent is that water may be neutralized because the chlorine gas is re-dissolved back to water.

U.S. Pat. Nos. 4,406,758, 4,457,953 and 4,891,107 also disclose various electrolysis apparatuses having a porous diaphragm and a hydrophobic carbon cathode. These patents are inevitably accompanied with the drawback that the operation of the apparatuses are troublesome because the amount or the rate of movement of the electrolyte solution from the anode chamber to the cathode chamber is difficult to control.

These apparatuses and methods fulfill their respective, particular objectives and requirements, but these apparatuses and methods have various drawbacks and shortcomings as mentioned above. Therefore, there exists a need for new apparatus and method for producing high pH alkaline water by use of electrolysis process, which are inexpensive, easy and convenient to control and has no harm to the environment and the people.

### SUMMARY OF THE INVENTION

The present invention is made in consideration of the above. It is a main object of the present invention to provide a method for electrolytically producing alkaline water using magnesium as anode and cathode electrodes without the provision of a separator between the electrodes. The method of the invention allows to eliminate the maintenance of the separator and the need to treat acid water. In this method, formation of chlorine is prevented because contact between the anode surface and chlorine ions present in water is diminished. It is not required to add chemicals into water to increase the pH value of water, and no chemical treatment is employed. Thus, the method of the invention is environment-friendly.

In order to achieve the above objects, a first aspect of this invention provides a method for electrolytically producing alkaline water, comprising the steps of:

(a) providing an electrolytic cell containing at least one anode electrode and at least one cathode electrode in a spaced manner, without a separator arranged between said at least one anode electrode and said at least one cathode electrode, both said anode and cathode electrodes being made of magnesium;

(b) supplying water to the electrolytic cell; and

(c) applying a direct current across said at least one anode electrode and said at least one cathode electrode for causing electrolysis of water in the electrolytic cell to produce alkaline water.

In one preferred embodiment of the invention, the method further comprises a step of providing a controller connected to said anode and cathode electrodes so as to operably reverse polarity of said electrodes. Preferably, the controller comprises a relay having two terminals connected to said anode electrode and said cathode electrode, respectively, and a timer for switching on/off the relay to reverse the polarity of said electrodes.

According to the invention, the reversal of the polarity of said electrodes takes place in the timing range of 1 min to 60 mins.

It has been revealed that said anode electrode and said cathode electrode are spaced apart at a desired distance, preferably, at the distance from 1 mm to 50 cm, the entire volume of water in the electrolytic cell can reach the desired pH value in a short time.

The direct current applied across the anode and cathode electrodes generally begins from 0.2 Amp onwards and can vary according to the requirements in practice. Advantageously the direct current ranges from 0.2 Amp to 10 Amp.

The water used in the invention can be selected from the group consisting of sea water, tap water, well water and waste water.

In a second aspect of the invention, there is provided an apparatus for electrolytically producing alkaline water, comprising:

a water electrolytic cell containing at least one anode electrode and at least one cathode electrode in a spaced manner, without a separator arranged between said at least one anode electrode and said at least one cathode electrode, both said anode and cathode electrodes being made of magnesium; and

a power source for applying a direct current across said at least one anode electrode and said at least one cathode electrode for causing electrolysis of water in the electrolytic cell to produce alkaline water.

It is preferable that the apparatus is equipped with a controller that is connected between said anode and cathode electrodes and said power source so as to operably reverse polarity of said electrodes.

A third aspect of the invention relates to use of the electrolytic alkaline water produced by the method of the invention in removing toxic components and greenhouse gases such as SO₂, NOₓ, and CO₂ in a flue gas.

As explained above, the method and apparatus of the invention have the following advantages over the prior art:
magnesium is abundantly found in earth and seawater, thus the use of magnesium electrodes is cost-effective and does not create additional undesired products to the environment when the side products of the electrolytic process are discharged;
magnesium electrodes is able to minimize the scaling problem during the electrolytic process, because the magnesium ions are released from the anode electrode and redeposit on the cathode electrode;
no separator is used, thus there is no need for the maintenance of the separator;
it is easy and convenient to control the movement of electrolyte solution because the whole volume of water treated by the invention is alkaline;
no chemicals are added to water, thus consequential treatment of the chemicals does not exist;
the formation of chlorine gas is significantly prevented because the contact between the anode surface and chlorine ions is greatly reduced;
the weight loss of the electrodes for reversing polarity periodically is less than that of the electrodes with fixed polarity, because magnesium ions are released from the anode electrode and re-deposit on the cathode electrode, and the polarity of the anode and cathode electrodes is reversed periodically.

To have a better understanding of the invention reference is made to the following detailed description of the invention and embodiments thereof in conjunction with the accompanying drawings.

### BRIEF DESCRIPTION OF THE DRAWINGS

FIG. 1 is a schematic view of an apparatus for producing alkaline water in an electrolytic cell having one anode and one cathode constructed in accordance with an embodiment of the invention.

### DETAILED DESCRIPTION OF THE PREFERRED EMBODIMENTS

While this invention is illustrated and described in preferred embodiments, the apparatus may be produced in many different configurations, sizes, and forms.

It is known that magnesium is one of the most abundant metals in earth and can be found in mineral rocks such as dolomite and magnesite. Many sources of magnesium in earth are mineral deposits left behind by oceans. Magnesium is also present in seawater and can be extracted from seawater in a relatively easy way, for example, by electrolysis. Therefore, if seawater is used as the electrolyte to produce alkaline water, the resultant magnesium side products such as magnesium salts, magnesium oxide etc. can be simply discharged to the sea without the need of further treatment of the side products, since the ocean is the source of a large part of magnesium in Earth, as described above. That is, the method of the invention using magnesium electrodes does not create additional undesired products to the environment, which is the case for electrodes of other metals such as sodium and calcium.

In the past, magnesium anode is widely used in cathodic protection as a sacrificial anode to produce the necessary current from the magnesium anode to protect the steel cathode. Typically, the magnesium anode is electrically connected to the steel cathode in an electrolytic cell, and a current is discharged from the magnesium anode due to the potential difference between the magnesium and the steel. Once the current enters the steel surface, the corrosion current on the steel surface will be suppressed, thereby reducing the corrosion. That is, this type of electrolytic cell using magnesium electrode merely takes advantage of the current from the magnesium electrode. Generally, the prior techniques employ an external current which passes through the anode using copper, steel, zinc or aluminum materials in order to increase the pH value of seawater. However, these metal ions are undesirable to the environment (the seawater).

Unlike the prior techniques, the invention utilizes magnesium as anode and cathode electrodes without a separator therebetween, wherein electrons are released from magnesium anode to discharge magnesium ions Mg²⁺, and the electrons react with H⁺ to produce hydrogen at the cathode. As mentioned above, the magnesium ions are naturally present in seawater and earth in large quantity, the resultant side products of the invention will not generate undesired products and hence avoid any impact on the environment.

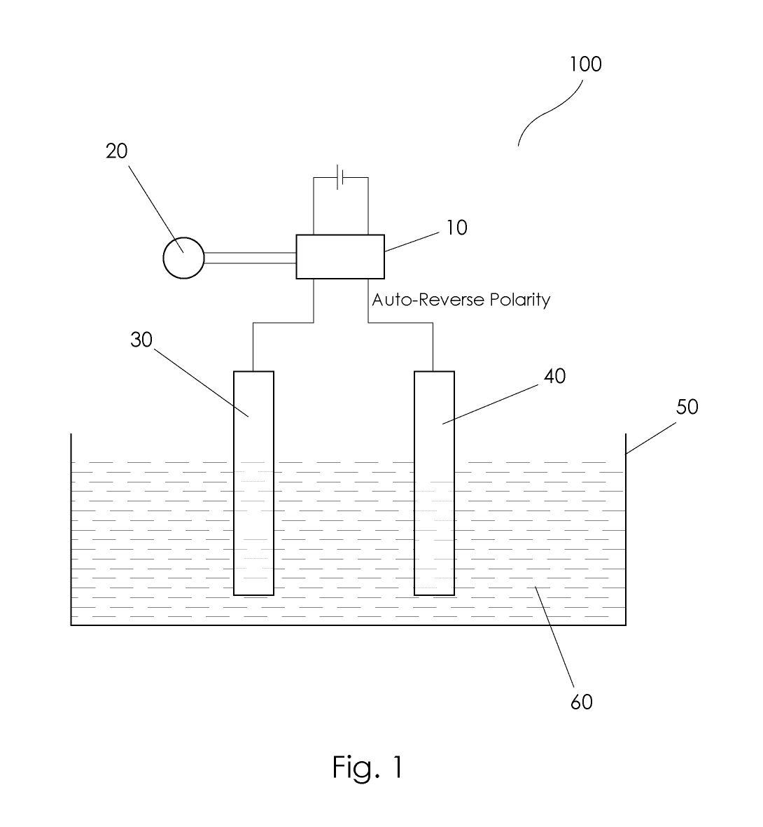

Referring now to the drawings, FIG. 1 provides an apparatus 100 constructed consistent with a preferred embodiment of the present invention. The apparatus 100 comprises an electrolytic cell 50 containing seawater 60, an anode electrode 30 and a cathode electrode 40 in a spaced manner, which are immersed in the seawater 60. The electrolytic cell 50 may be of any size, shape and configuration. In this embodiment, the electrolytic cell 50 is made of steel material and substantially rectangular. The anode electrode 30 and the cathode electrode 40 are both made of magnesium.

As shown in FIG. 1, there is no separator or diaphragm arranged between the anode electrode 30 and the cathode electrode 40. Because of the elimination of the separator, the whole volume of the water treated by the invention is alkaline and no acid water is produced as done by the prior apparatuses with a separator, thereby the secondary treatment of acid water is avoided. The apparatus 100 of the invention also eliminates the need for maintaining the separator, the separator of poor quality may affect the production of alkaline water.

A direct current is applied across the anode electrode 30 and the cathode electrode 40 to enable the electrolysis of water. The direct current may vary according to the different requirements in practice. For example, the direct current may range from 0.2 Amp to 10 Amp at a voltage ranging from 1.0V to 5V.

In the electrolytic cell 50, magnesium ions are produced at the anode according to

Mg→Mg²⁺+2e

the released electrons flow towards the cathode, while hydrogen is evolved at the cathode according to the reaction:

2H⁺+2e→H₂

As the magnesium ions are discharged at the anode, this reduces the likelihood that chloride ions come into contact with the anode electrode. As a result, the generation of chlorine gas is prevented. It has been found in the invention that the apparatus 100 is substantially free from chlorine gas during the process of producing the alkaline water, which is a great advantage over the prior apparatuses and methods in the art.

According to the invention, the whole volume of the water under treatment can reach the desired pH value in a short time if the anode and cathode electrodes are spaced apart at a certain distance, for example at a distance from 1 mm to 50 cm.

It is known that an electrolytic cell is continuously used for a long period of time, the electrolytic efficiency decreases gradually, due to deposition of scale on the electrodes. In order to prevent the successive diminution of the electrolytic efficiency due to the accumulation of the scale, the scale deposited on the surfaces of the electrodes need to be removed mechanically or manually. One approach to avoid the accumulation of the scale is to perform the electrolysis with the polarities of electric currents applied to the anode and the cathode reversed periodically. However, in this case, the steel or other metal electrodes of the apparatuses in the prior art become anode electrodes, Fe ions and other metal ions will be discharged into seawater and cause an environmental issue to seawater.

In contrast, one advantage of the apparatus 100 of the invention is that the scale deposition is greatly diminished during the electrolytic process, because the magnesium anode and the magnesium cathode are used. When the direct current is applied between the anode and the cathode, the magnesium ions are discharged from the anode, and redeposit on the cathode. Therefore, discharging undesirable metal ions into seawater is avoided. To further minimize the scale problem, the apparatus 100 utilizes a controller for reversing polarity of the electrodes periodically.

Referring again to FIG. 1, the apparatus 100 further comprises a relay 10 and a timer 20 connected to the relay 10. The relay 10 has two terminals which are connected to the anode electrode 30 and the cathode 40, respectively. The relay 10 has another two terminals which are connected to the power source. The relay 10 is arranged to operably reverse the polarity of the anode and cathode electrodes in a determined period of time. The timer 20 is provided to automatically switch on/off the relay 10 in the determined period of time, so as to reverse the polarity of the electrodes. In the apparatus 100 illustrated in FIG. 1, the electrodes 30 and 40 are first connected to the electric power source so as to use the electrodes 30 and 40 as an anode and a cathode, respectively to conduct the electrolysis of seawater 60 in the electrolytic cell 50. After a determined period of time, for example, from 1 min to 60 mins, the electrolysis is conducted under the same conditions, but the relay 10 is switched on to reverse the polarities of electric currents applied to the electrodes 30 ad 40 so as to use the electrodes 30 and 40 as a cathode and an anode, respectively.

As discussed above, the use of magnesium as anode and cathode electrodes in combination of periodical reversal of the polarity of the magnesium electrodes not only prevents the scale deposition on the electrodes, but also reduces the magnesium consumption rates due to the re-deposition of magnesium. Of course, cleaning the electrode is avoided.

### EXAMPLES

Experiments using the apparatus 100 illustrated in FIG. 1 having seawater as an electrolyte have been carried out on the following conditions:

electric current: 0.2 Amp to 10 Amp

voltage used: 1.0 V to 5 V

temperature: 23° C. to 50° C.

auto-reversal time: 2 min to 60 min

The results revealed that the pH value of the seawater having pH 3 to pH 8.5 increased to pH 9.5 to pH 13.5, subject to about 8 to 20 minutes, preferably about 10 minutes of the electrolysis in the apparatus 100. This is relatively faster than the electrolysis apparatuses using inert electrodes and thus greatly decreases the time of producing the alkaline water of high pH value.

The invention makes good use of electrolysis of water, which is not involved in the use of chemicals, thus there is no harm to the environment. It has been found that the method of the invention not only increases the pH value of the water, but also increases the alkalinity of the water. Alkalinity is defined to be a measure of the buffering capacity of a solution, or the capacity of bases to neutralize acids.

As discussed above, alkaline water produced by the method of the invention finds a wide range of applications. One of the applications is its use for removing toxic components and greenhouse gases such as SO₂, NOₓ, and CO₂ in a flue gas. The method for removing the toxic components and greenhouse gases had been detailed in Applicant's another PCT application no. PCT/CN2009/070110, the entire disclosure of which is incorporated herein by reference. According to the invention, the obtained alkaline water has pH 9.5 to 13.5 with the increase in the alkalinity of the water, which is beneficial to improve the absorption result. When the alkaline water is used to treat the toxic components and greenhouse gases, the alkaline water after absorption has a similar pH to the seawater because of its increased alkalinity, which eliminates the need of a large amount of fresh seawater to dilute the water to be discharged, so that the discharged water meets the environment requirement.

Thus, the invention provides method and apparatus for electrolytically producing alkaline water using magnesium as anode and cathode electrodes without a separator disposed therebetween. As described above, the method and the apparatus of the invention are very simple and convenient, environment-friendly, and enable to produce the alkaline water at very low costs.

While the embodiments described herein are intended as an exemplary apparatus, it will be appreciated by those skilled in the art that the present invention is not limited to the embodiments illustrated. Those skilled in the art will envision many other possible variations and modifications by means of the skilled person's common knowledge without departing from the scope of the invention, however, such variations and modifications should fall into the scope of this invention.

1-17. (canceled)

17. A method for electrolytically producing alkaline water, the method comprising:
(a) providing an electrolytic cell containing at least one anode electrode and at least one cathode electrode in a spaced manner, without a separator arranged between the at least one anode electrode and the at least one cathode electrode, both the anode and cathode electrodes comprising magnesium;
(b) supplying water to the electrolytic cell; and
(c) applying a direct current across the at least one anode electrode and the at least one cathode electrode for causing electrolysis of water in the electrolytic cell to produce alkaline water.

18. The method according to claim 17, further comprising providing a controller connected to the anode and cathode electrodes so as to operably reverse polarity of the electrodes.

19. The method according to claim 18, wherein the controller comprises a relay having two terminals connected to the anode electrode and the cathode electrode, respectively, and a timer for on/off switching of the relay to reverse the polarity of the electrodes.

20. The method according to claim 19, wherein the reversal of the polarity of the electrodes takes place in the range of 1 minute to 60 minutes.

21. The method according to claim 17, wherein the anode electrode and the cathode electrode are spaced apart at a distance from 1 mm to 50 cm.

22. The method according to claim 18, wherein the anode electrode and the cathode electrode are spaced apart at a distance from 1 mm to 50 cm.

23. The method according to claim 19, wherein the anode electrode and the cathode electrode are spaced apart at a distance from 1 mm to 50 cm.

24. The method according to claim 17, wherein the direct current starts from 0.2 Amp.

25. The method according to claim 18, wherein the direct current starts from 0.2 Amp.

26. The method according to claim 319, wherein the direct current starts from 0.2 Amp.

27. The method according to claim 17, wherein the water is selected from the group consisting of sea water, tap water, well water and waste water.

28. The method according to claim 18, wherein the water is selected from the group consisting of sea water, tap water, well water and waste water.

29. The method according to claim 19, wherein the water is selected from the group consisting of sea water, tap water, well water and waste water.

30. An apparatus for electrolytically producing alkaline water, comprising:
a water electrolytic cell containing at least one anode electrode and at least one cathode electrode in a spaced manner, without a separator arranged between the at least one anode electrode and the at least one cathode electrode, both the anode and cathode electrodes comprising magnesium; and
a power source for applying a direct current across the at least one anode electrode and the at least one cathode electrode for causing electrolysis of water in the electrolytic cell to produce alkaline water.

31. The apparatus according to claim 30, wherein a controller is connected between the anode and cathode electrodes and the power source so as to operably reverse polarity of the electrodes.

32. The apparatus according to claim 31, wherein the controller comprises a relay having two terminals connected to the anode electrode and the cathode electrode, respectively, and a timer for switching on/off the relay to reverse the polarity of the electrodes.

33. The apparatus according to claim 32, wherein the reversal of the polarity of the electrodes takes place in the range of 1 min to 60 mins.

34. The apparatus according to claim 30, wherein the anode electrode and the cathode electrode is spaced apart at a distance from 1 mm to 50 cm.

35. The apparatus according to claim 31, wherein the anode electrode and the cathode electrode is spaced apart at a distance from 1 mm to 50 cm.

36. The apparatus according to claim 32, wherein the anode electrode and the cathode electrode is spaced apart at a distance from 1 mm to 50 cm.

37. The apparatus according to claim 30, wherein the direct current starts from 0.2 Amp.

38. The apparatus according to claim 31, wherein the direct current starts from 0.2 Amp.

39. The apparatus according to claim 32, wherein the direct current starts from 0.2 Amp.

40. The apparatus according to claim 30, wherein the water is selected from the group consisting of sea water, tap water, well water and waste water.

41. The apparatus according to claim 31, wherein the water is selected from the group consisting of sea water, tap water, well water and waste water.

42. The apparatus according to claim 32, wherein the water is selected from the group consisting of sea water, tap water, well water and waste water.

43. Use of the electrolytic alkaline water produced by the method of claim 17 in removing toxic components and greenhouse gases in a flue gas.

44. Use of the electrolytic alkaline water produced by the method of claim 18 in removing toxic components and greenhouse gases in a flue gas.

45. Use of the electrolytic alkaline water produced by the method of claim 19 in removing toxic components and greenhouse gases in a flue gas.

46. The use according to claim 43, wherein the gases are selected from the group consisting of SO2, NOx, and CO2.
